(19) United States
(12) Patent Application Publication
(10) Pub. No.: US 2010/0105316 A1
(43) Pub. Date: Apr. 29, 2010

(54) MULTIPLE-INPUT MULTIPLE-OUTPUT RELAY SYSTEM AND METHOD

(75) Inventors: DoHoon KIM, Goyang-si (KR); Young-Chai Ko, Seoul (KR); Byung Gueon Min, Seongnam (KR)

Correspondence Address: RABIN & Berdo, PC, 1101 14TH STREET, NW, SUITE 500, WASHINGTON, DC, 20005, US

(73) Assignee: NewTel Technology Inc., Seoul (KR)

(21) Appl. No.: 12/257,150

(22) Filed: Oct. 23, 2008

(51) Int. Cl. H04B 7/14

(52) U.S. Cl. 455/8; 370/230

(57) ABSTRACT

A Multiple-Input Multiple-Output (MIMO) relay system is provided. The MIMO relay system performs signal processing to provide requested real data to at least one selected user mobile station sequentially connected to a first relay station located in a first cell and a second relay station located in a second cell using spare frequency capacity allocated to a first base station of the first cell instead of a second base station of the second cell that drops the requested real data due to its frequency capacity being exceeded, thereby improving reliability of seamless real data input/output in relay communication, reducing call drop probability, and raising availability of frequency capacity by automatically adjusting frequency capacity allocated between cells.

### BACKGROUND OF THE INVENTION

1. Field of the Invention

The present invention relates to Multiple-Input Multiple-Output (MIMO) communication technologies and, more particularly, to a MIMO relay system and method that perform signal processing to provide requested real data to at least one selected user Mobile Station (MS) sequentially connected to a plurality of Relay Stations (RSs) using spare frequency capacity allocated to another Base Station (BS) instead of a BS that drops the requested real data due to its frequency capacity being exceeded.

2. Description of the Related Art

In general, a cellular system is configured with small-sized service areas called cells by dividing the entire service coverage region into a plurality of BS areas. When a mobile station center (MSC) controls BSs in a concentrated manner, user mobile stations may continue communication while on the move between cells.

In this case, since a plurality of user MSs located in the cellular system are differently distributed between cells, at least one user MS may be located in a cell with a BS whose channel capacity has been exceeded.

Even when another user MS additionally joins the cell with the BS whose channel capacity has been exceeded, the BS within the cell does not accommodate the additional user MS due to the limited channel capacity.

That is, the conventional cellular system has a problem that call drop probability increases and spectral efficiency decreases due to imbalanced channel allocation between the BS with limited channel capacity and the additional user MS, thereby degrading reliability of a mobile communication network.

### SUMMARY OF THE INVENTION

The present invention provides a MIMO relay system and method that can perform signal processing to provide requested real data to at least one selected user MS sequentially connected to a first RS located in a first cell and a second RS located in a second cell using spare frequency capacity allocated to a first BS of the first cell instead of a second BS of the second cell that drops the requested real data due to its frequency capacity being exceeded, thereby improving reliability of seamless real data input/output in relay communication, reducing call drop probability, and raising availability of frequency capacity by automatically adjusting frequency capacity allocated between cells.

According to exemplary embodiments of the present invention, a MIMO relay system in which a first BS and a first RS are located in a first cell, and a second BS, a second RS, and at least one selected user MS of a plurality of user MSs are located in a second cell, includes: processing, when the at least one user MS requests real data to be received by accessing the second BS whose frequency capacity has been exceeded, signals to enable the requested real data to be provided to the at least one user MS sequentially connected to the first and second RSs using spare frequency capacity allocated to the first BS instead of the second BS which drops the requested real data.

According to a first exemplary embodiment of the present invention, a MIMO relay system in which a first BS and a first RS are located in a first cell, a second RS dropping requested N real data, a second RS, and at least one selected user MS of a plurality of user MSs are located in a second cell, a first MIMO channel is formed between the first BS and the first RS, a second MIMO channel is formed between the first RS and the second RS, and a Multiple-Input Single-Output (MISO) channel is formed between the second RS and the at least one selected user MS, includes: the first BS having multiple transmit antennas in which first transmit antenna interference occurs when the first MIMO channel is formed, and generating and transmitting N different first BS real data after removing user interference generated by user MSs from the N real data and removing the first transmit antenna interference from N information values amplified and converted by applying N different powers in 1:1 correspondence; the first RS having multiple transmit antennas in which second transmit antenna interference occurs when the second MIMO channel is formed, transmitting N different first relay real data amplified and converted by applying a first RS amplification gain to the transmitted N different first BS real data in a first time slot, and receiving the N different first BS real data from the first BS in a second time slot; and the second RS having multiple transmit antennas in which third transmit antenna interference occurs when the MISO channel is formed, providing the at least one selected user MS with N different second relay real data re-amplified and converted by applying a second RS amplification gain to the transmitted N different first relay real data in a third time slot, and receiving the N different first relay real data from the first RS in a fourth time slot, wherein the first BS provides the first RS with the N different first BS real data signal-processed by removing the second and third transmit antenna interference from the amplified and converted N information values is provided.

According to a second exemplary embodiment of the present invention, a MIMO relay system in which a first BS and a first RS are located in a first cell, a second RS dropping requested N real data, a second RS, and at least one selected user MS of a plurality of user MSs are located in a second cell, a first MIMO channel is formed between the first BS and the first RS, a second MIMO channel is formed between the first RS and the second RS, and a MISO channel is formed between the second RS and the at least one selected user MS, includes: the first BS having multiple transmit antennas in which first transmit antenna interference occurs when the first MIMO channel is formed, and generating and transmitting N different first BS real data after removing user interference generated by user MSs from the N real data and removing the first transmit antenna interference from N information values amplified and converted by applying N different first powers in 1:1 correspondence; the first RS having multiple transmit and receive antennas in which receive antenna interference occurs when the first MIMO channel is formed and second transmit antenna interference occurs when the second MIMO channel is formed, generating and transmitting N different first relay real data after removing the receive antenna interference from the transmitted N different first BS real data and removing the second transmit antenna interference from N second information values amplified and converted by applying N different second powers in 1:1 correspondence in a first time slot, and receiving the N different first BS real data from the first BS in a second time slot; and the second RS having multiple transmit antennas in which third transmit antenna interference occurs when the MISO channel is formed, providing the at least one selected user MS with N different second relay real data re-amplified and converted by applying a second RS amplification gain to the transmitted N different first relay real data in a third time slot, and receiving the N different first relay real data from the first RS in a fourth time slot, wherein the first RS provides the second RS with the N different first relay real data signal-processed by removing the third transmit antenna interference from the amplified and converted N information values is provided.

Preferably, the first BS comprises: a Zero-Forcing Dirty Paper Coding (ZF-DPC) unit generating N user interference-removed real data by removing the user interference generated by the user MSs from the N real data; a first power supply generating N different power real data amplified and converted by applying the N different powers to the N user interference-removed real data in 1:1 correspondence; and an antenna interference detection and removal unit generating the N different first BS real data signal-converted by removing all the first, second, and third transmit antenna interference from the N different power real data.

Preferably, the first RS comprises: a second power supply generating the N different first relay real data amplified and converted by applying the same first RS amplification gain to the N different first BS real data.

Preferably, the second RS comprises: a third power supply generating the N different second relay real data re-amplified and converted by applying the same second RS amplification gain to the N different first relay real data.

Preferably, the N different second relay real data are N different multimedia information values signal-processed to be transmitted to the at least one selected user MS corresponding to a target end via the first BS, the first RS, and the second RS.

According to a third exemplary embodiment of the present invention, a MIMO relay method in which a first BS and a first RS are located in a first cell, a second RS dropping requested N real data, a second RS, and at least one selected user MS of a plurality of user MSs are located in a second cell, a first MIMO channel is formed between the first BS and the first RS, a second MIMO channel is formed between the first RS and the second RS, and a MISO channel is formed between the second RS and the at least one selected user MS, includes: generating, by the first BS, N user interference-removed real data by removing user interference generated by user MSs from the N real data; generating, by the first BS, N different first power real data amplified and converted by applying N different first powers to the N user interference-removed real data in 1:1 correspondence; detecting, by the first BS, first transmit antenna interference affecting its multiple transmit antennas when the first MIMO channel is formed; detecting, by the first RS, first receive antenna interference affecting its multiple receive antennas when the first MIMO channel is formed and second transmit antenna interference affecting its multiple transmit antennas when the second MIMO channel is formed; detecting, by the second RS, second receive antenna interference affecting its multiple receive antennas when the second MIMO channel is formed and third transmit antenna interference affecting its multiple transmit antennas when the MISO channel is formed; providing, by the first BS, the first RS with N different first BS real data produced by removing the first transmit antenna interference from the N different first power real data; generating, by the first RS, N different first relay reception stage interference-removed real data by removing the first receive antenna interference from the N different first BS real data; generating, by the first RS, N different first relay amplification real data amplified and converted by applying N different second powers to the N different first relay reception stage interference-removed real data in 1:1 correspondence in a first time slot; providing, by the first RS, the second RS with N different first relay real data produced by removing the second transmit antenna interference from the N different first relay amplification real data; receiving, by the first RS, N different first BS real data from the first BS in a second time slot; generating, by the second RS, N different second relay reception stage interference-removed real data by removing the second receive antenna interference from the provided N different first relay real data; generating, by the second RS, N different second relay amplification real data re-amplified and converted by applying N different third powers to the N different second relay reception stage interference-removed real data in 1:1 correspondence in a third time slot; providing, by the second RS, the at least one selected user MS with N different second relay real data produced by removing the third transmit antenna interference from the N different second relay amplification real data; and receiving, by the second RS, N different first relay real data from the first RS in a fourth time slot is provided.

Preferably, the first BS comprises: a ZF-DPC unit generating N user interference-removed real data by removing the user interference generated by the user MSs from the N real data; a first power supply generating N different first power real data amplified and converted by applying the N different first powers to the N user interference-removed real data in 1:1 correspondence; and a first antenna interference detection and removal unit generating the N different first BS real data signal-converted by removing the first transmit antenna interference from the N different first power real data.

Preferably, the first RS comprises: a second antenna interference detection and removal unit generating N different first relay reception stage interference-removed real data by removing the receive antenna interference generated by the multiple receive antennas from the N different first BS real data; a second power supply generating N different first relay amplification real data amplified and converted by applying N different second powers to the N different first relay reception stage interference-removed real data in 1:1 correspondence; and a third antenna interference detection and removal unit generating the N different first relay real data signal-converted by removing the second and third transmit antenna interference from the N different first relay amplification real data.

Preferably, the second RS comprises: a third power supply generating the N different second relay real data re-amplified and converted by applying the same second RS amplification gain to the N different first relay real data.

Preferably, the N different second relay real data are N different multimedia information values signal-processed to be transmitted to the at least one selected user MS corresponding to a target end via the first BS, the first RS, and the second RS.

According to a fourth embodiment of the present invention, a MIMO relay method in which a first BS and a first RS are located in a first cell, a second RS dropping requested N real data, a second RS, and at least one selected user MS of a plurality of user MSs are located in a second cell, a first MIMO channel is formed between the first BS and the first RS, a second MIMO channel is formed between the first RS and the second RS, and a MISO channel is formed between the second RS and the at least one selected user MS, the method comprising:

generating, by the first BS, N user interference-removed real data by removing user interference generated by user MSs from the N real data; generating, by the first BS, N different first power real data amplified and converted by applying N different first powers to the N user interference-removed real data in 1:1 correspondence; detecting, by the first BS, first transmit antenna interference affecting its multiple transmit antennas when the first MIMO channel is formed; detecting, by the first RS, first receive antenna interference affecting its multiple receive antennas when the first MIMO channel is formed and second transmit antenna interference affecting its multiple transmit antennas when the second MIMO channel is formed; detecting, by the second RS, second receive antenna interference affecting its multiple receive antennas when the second MIMO channel is formed and third transmit antenna interference affecting its multiple transmit antennas when the MISO channel is formed; providing, by the first BS, the first RS with N different first BS real data produced by removing the first transmit antenna interference from the N different first power real data; generating, by the first RS, N different first relay reception stage interference-removed real data by removing the first receive antenna interference from the N different first BS real data; generating, by the first RS, N different first relay amplification real data amplified and converted by applying N different second powers to the N different first relay reception stage interference-removed real data in 1:1 correspondence in a first time slot; providing, by the first RS, the second RS with N different first relay real data produced by removing the second transmit antenna interference from the N different first relay amplification real data; receiving, by the first RS, N different first BS real data from the first BS in a second time slot; generating, by the second RS, N different second relay reception stage interference-removed real data by removing the second receive antenna interference from the provided N different first relay real data; generating, by the second RS, N different second relay amplification real data re-amplified and converted by applying N different third powers to the N different second relay reception stage interference-removed real data in 1:1 correspondence in a third time slot; providing, by the second RS, the at least one selected user MS with N different second relay real data produced by removing the third transmit antenna interference from the N different second relay amplification real data; and receiving, by the second RS, N different first relay real data from the first RS in a fourth time slot is provided.

Preferably, the method further comprises: in the first BS, generating, by a ZF-DPC unit, the N user interference-removed real data by removing the user interference generated by the user MSs from the N real data, generating, by a first power supply, the N different first power real data amplified and converted by applying the N different first powers to the N user interference-removed real data in 1:1 correspondence; and generating, by a first antenna interference and removal unit, generates the N different first BS real data signal-converted by removing the first transmit antenna interference from the N different first power real data.

Preferably, the method further comprises: in the first RS, generating, by a second antenna interference detection and removal unit, the N different first relay reception stage interference-removed real data by removing the receive antenna interference generated by its multiple receive antennas from the N different first BS real data; generating, by a second power supply, the N different first relay amplification real data amplified and converted by applying the N different second powers to the N different first relay reception stage interference-removed real data in 1:1 correspondence; and generating, by a third antenna interference detection and removal unit, the N different first relay real data signal-converted by removing the second transmit antenna interference from the N different first relay amplification real data.

Preferably, the method further comprises: in the second RS, generating, by a fourth antenna interference and removal unit, the N different second relay reception stage interference-removed real data by removing the receive antenna interference generated by its multiple receive antennas from the N different first relay real data; generating, by a third power supply, the N different second relay amplification real data amplified and converted by applying the N different third powers to the N different second relay reception stage interference-removed real data in 1:1 correspondence; and generating, by a fifth antenna interference detection and removal unit, the N different second relay real data signal-converted by removing the third transmit antenna interference from the N different second relay amplification real data.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 shows a MIMO relay system on a mobile communication network according to exemplary embodiments of the present invention;

FIG. 2 is a block diagram of a MIMO relay system on a mobile communication network according to a first exemplary embodiment of the present invention;

FIG. 3 is a flowchart showing a MIMO relay method on the mobile communication network according to the first exemplary embodiment of the present invention;

FIG. 4 is a block diagram of a MIMO relay system on a mobile communication network according to a second exemplary embodiment of the present invention;

FIG. 5 is a flowchart showing a MIMO relay method on the mobile communication network according to the second exemplary embodiment of the present invention;

FIG. 6 is a block diagram of a MIMO relay system on a mobile communication network according to a third exemplary embodiment of the present invention; and

FIG. 7 is a flowchart showing a MIMO relay method on the mobile communication network according to the third exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown.

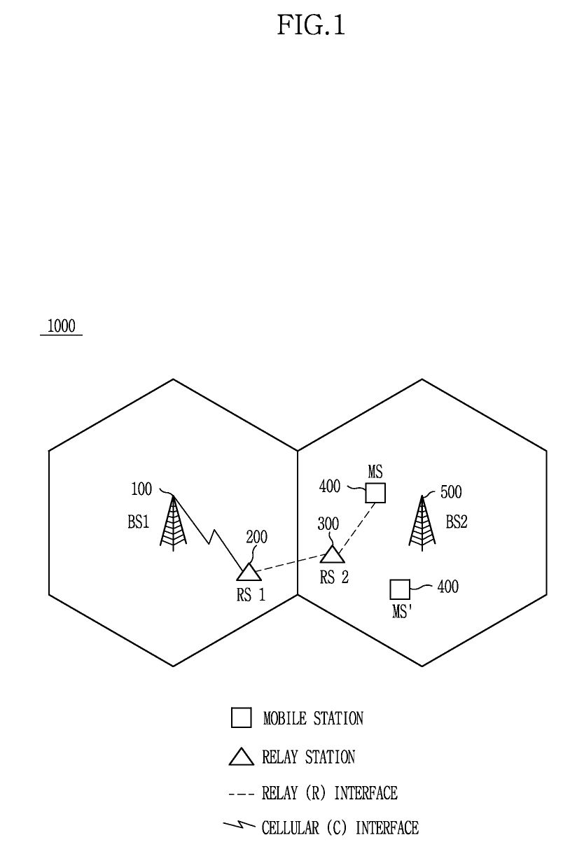

FIG. 1 shows a MIMO relay system on a mobile communication network according to exemplary embodiments of the present invention.

Referring to FIG. 1, a MIMO relay system 1000 includes a first BS 100, a second BS 500, a first RS 200, a second RS 300, and at least one selected user MS 400.

When at least one selected user MS 400 requests real data by accessing the second BS 500 whose allocated frequency capacity has been exceeded by use of a plurality of user MSs, the second BS 500 drops requested real data transmission due to its frequency capacity having been exceeded and the first BS 100 of a first cell provides at least one selected user MS 400 with the real data to be transmitted via the first RS 200 located in the first cell and the second RS 300 located in a second cell using a spare of allocated frequency capacity of the first BS 100. Therefore, the MIMO relay system 1000 can improve reliability of seamless real data input/output in relay communication, reduce call drop probability, and raise availability of frequency capacity by automatically adjusting frequency capacity allocated between cells.

Exemplary embodiments of the present invention are performed when at least one selected user MS 400 does not directly receive real data from the second BS 500 since the at least one selected user MS 400 is far away from the second BS 500 of the second cell including the at least one selected user MS 400, the second BS 500 whose allocated frequency capacity has been exceeded by use of a plurality of user MSs, or the at least one selected user MS 400 is located in a shadow area.

That is, the first BS 200 located in the first cell allocates available frequency capacity to the at least one selected user MS 400 located in the second cell, thereby enabling the user MS 400 to receive the real data via the first and second RSs.

Even when a distance between the second BS and the at least one selected user MS located in the same second cell is far, the second BS transmits the real data to the user MS 400 using the first and second RSs 200 and 300.

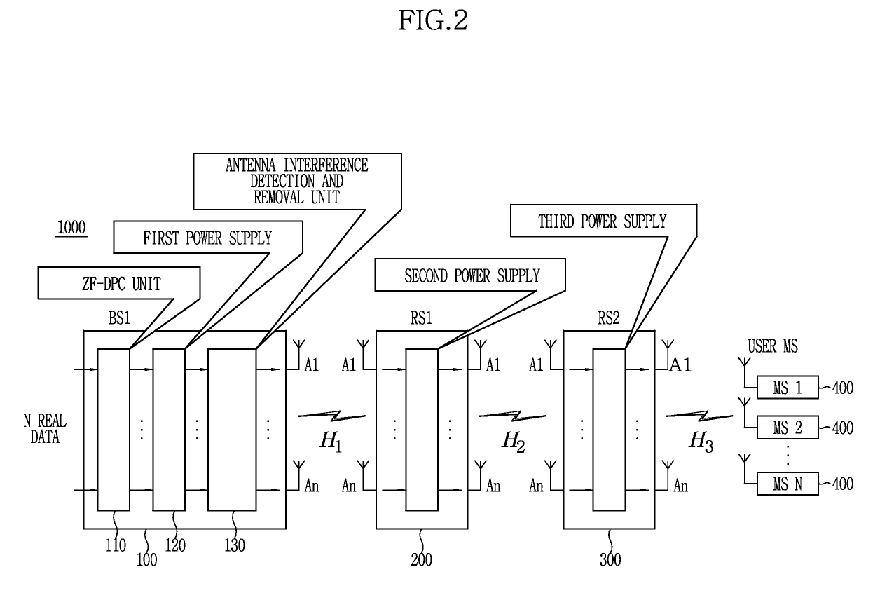

FIG. 2 is a block diagram of a MIMO relay system on a mobile communication network according to a first exemplary embodiment of the present invention.

Referring to FIG. 2, a MIMO relay system 1000 according to the first exemplary embodiment includes a first BS (BS1) 100 having multiple transmit/receive antennas in a first cell, a first RS (RS1) 200 having multiple transmit/receive antennas in the first cell, a second RS (RS2) 300 having multiple transmit/receive antennas in a second cell, and a user MS 400 located in the second cell.

The MIMO relay system 1000 further includes a second BS (BS2) 500 having multiple antennas in the second cell.

A first MIMO channel H₁ is formed between the first BS 100 and the first RS 200 belonging to the first cell. A second MIMO channel H₂ is formed between the first RS 200 belonging to the first cell and the second RS 300 belonging to the second cell.

A multiple-input single-output (MISO) channel H₃ is formed between the second RS 300 and the user MS 400.

When the first BS 100 transmits a payload or real data containing N different multimedia information values to the user MS 400 located in the second cell in a mobile communication environment according to the first exemplary embodiment of the present invention, user interference generated from a plurality of user MSs located in the second cell is first removed by applying the user interference to a Zero-Forcing Dirty Paper Coding (ZF-DPC) unit 110.

The first BS 100 provides the first RS 200 located in the first cell with N user interference-removed real data converted and generated by removing the user interference from N real data by applying N different powers P₁, P₂, - - - , P_{N} to the N user interference-removed real data in 1:1 correspondence.

The N user interference-removed real data are amplified and converted into N different power real data by a composite operation with the N different powers P₁, P₂, - - - , P_{N} provided from a first power supply 120 of the first BS 100 in 1:1 correspondence.

When the first and second MIMO channels H₁ and H₂ and the MISO channel H₃ are formed, the first BS 100 detects first, second, and third transmit antenna interference affecting multiple transmit antennas provided in the first BS 100, the first RS 200, and the second RS 300 through an internally configured antenna interference detection and removal unit 130.

The first BS 100 generates N different first BS real data signal-converted by removing all the first, second, and third transmit antenna interference from the N different power real data using the antenna interference detection and removal unit 130, and provides the first RS 200 located in the first cell with the N different first BS real data.

The first RS 200 processes the N different first BS real data signal-converted and transmitted from the first BS 100 using a half-duplex communication mode in which transmission and reception are time-divided and an Amplify-and-Forward (AF) mode.

That is, the first RS 200 performs signal amplification by applying a first RS amplification gain g₁ corresponding to the same transmit power value provided from an internally configured second power supply to the N different first BS real data received from the first BS 100 in a first time slot ts1.

The first RS 200 generates N different first relay real data converted and processed by the signal amplification and transmits the N different first relay real data to the second RS 300.

In a second time slot ts2, the first RS 200 receives N different first BS real data from the first BS 100.

In summary, the first RS 200 transmits the N different first relay real data to the second RS 300 by amplifying the N different first BS real data transmitted from the first BS 100 in the half-duplex communication mode and the AF mode in the first time slot ts1.

In the second time slot ts2, the first RS 200 receives N different first BS real data from the first BS 100.

Subsequently, the second RS 300 located in the second cell directly follows the half-duplex communication mode and the AF mode applied to the first RS 200.

Since the first RS amplification gain g₁ applied to the N different first relay real data input from the first RS 200 has been consumed during relay transmission, the second RS 300 newly applies a second RS amplification gain g₂ required for re-amplification and transmission to the user MS 400 to the N different first relay real data received from the first RS 200.

That is, the second RS 300 performs signal re-amplification by applying the second RS amplification gain g₂ corresponding to the same transmit power value provided from an internally configured third power supply to the N different first relay real data received from the first RS 200 in the first time slot ts1.

The second RS 300 generates N different second relay real data converted and processed by the signal re-amplification and transmits the N different second relay real data to the user MS 400 located in the second cell.

In the second time slot ts2, the second RS 300 receives N different first relay real data from the first RS 200.

Here, the N different second relay real data are N different multimedia information values whose signals have been processed to be transmitted to at least one selected user MS corresponding to a target end via the first BS, the first RS, and the second RS.

In summary, the second RS 300 transmits the N different second relay real data to the user MS 400 located in the second cell by amplifying the N different first relay real data transmitted from the first RS 200 in the half-duplex communication mode and the AF mode in the first time slot ts1.

In the second time slot ts2, the second RS 300 receives N different first relay real data from the first RS 200.

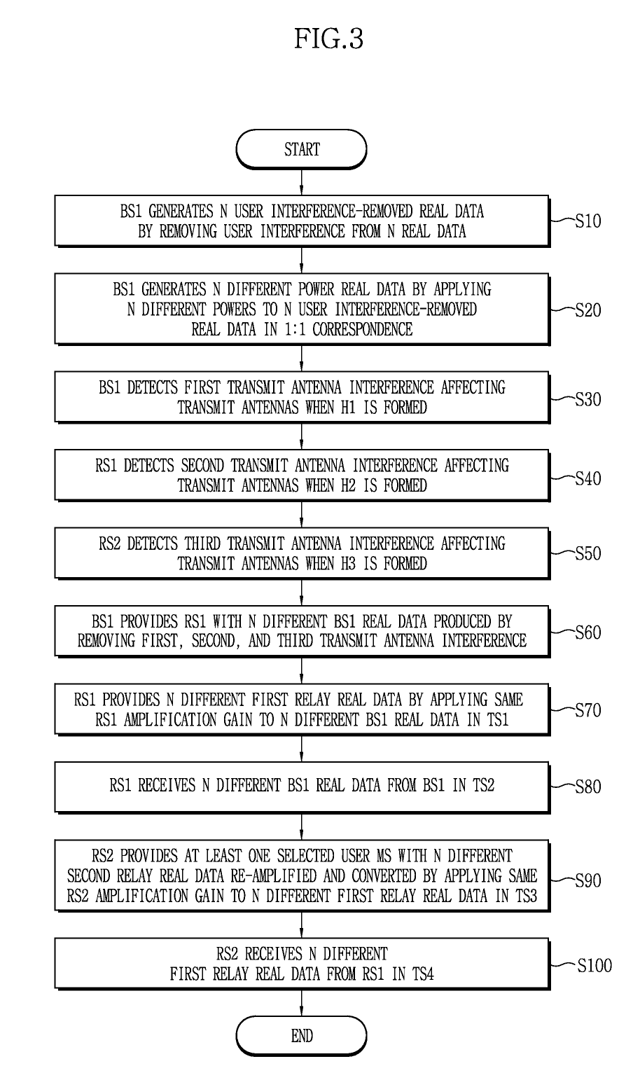

FIG. 3 is a flowchart showing a MIMO relay method on the mobile communication network according to the first exemplary embodiment of the present invention.

Referring to FIG. 3, the MIMO relay method of the first exemplary embodiment operates in a mobile communication environment where the first BS and the first RS are included in the first cell, the second RS and a plurality of user MSs are included in the second cell, the first MIMO channel is formed between the first BS and the first RS, the second MIMO channel is formed between the first RS and the second RS, or the MISO channel is formed between the second RS and at least one selected user MS of the user MSs as follows.

First, the first BS generates N user interference-removed real data by removing user interference generated by multiple user MSs from N real data to be transmitted to the at least one selected user MS (S10).

The first BS generates N different power real data amplified and converted by applying N different powers to the N user interference-removed real data in 1:1 correspondence (S20).

When the first MIMO channel is formed, the first BS detects first transmit antenna interference affecting its multiple transmit antennas (S30).

When the second MIMO channel is formed, the first RS detects second transmit antenna interference affecting its multiple transmit antennas (S40).

When the MISO channel is formed, the second RS detects third transmit antenna interference affecting its multiple transmit antennas (S50).

The first BS provides the first RS with N different first BS real data produced by removing all the first, second, and third transmit antenna interference from the N different power real data (S60).

The first RS provides an outside device with N different first relay real data amplified and converted by applying the same first RS amplification gain to the transmitted N different first BS real data in a first time slot (S70).

The first RS receives N different first BS real data from the first BS in time division in a second time slot (S80).

The second RS provides at least one selected user MS with N different second relay real data re-amplified and converted by applying the same second RS amplification gain to the N transmitted different first relay real data in a third time slot (S90).

The second RS receives N different first relay real data from the first RS in time division in a fourth time slot (S100).

Additional operations of devices configured inside the first BS, the first RS, and the second RS are as follows.

The first BS internally includes a ZF-DPC unit, a first power supply, and an antenna interference detection and removal unit.

The ZF-DPC unit generates N user interference-removed real data by removing user interference generated by multiple user MSs from N real data. The first power supply generates N different power real data amplified and converted by applying N different powers to the N user interference-removed real data in 1:1 correspondence.

The antenna interference and removal unit generates N different first BS real data signal-converted by removing all first, second, and third transmit antenna interference from the N different power real data.

The first RS internally includes a second power supply, and the second RS internally includes a third power supply.

The second power supply of the first RS generates N different first relay real data amplified and converted by applying the same first RS amplification gain to the N different first BS real data. The third power supply of the second RS generates N different second relay real data re-amplified and converted by applying the same second RS amplification gain to the N different first relay real data.

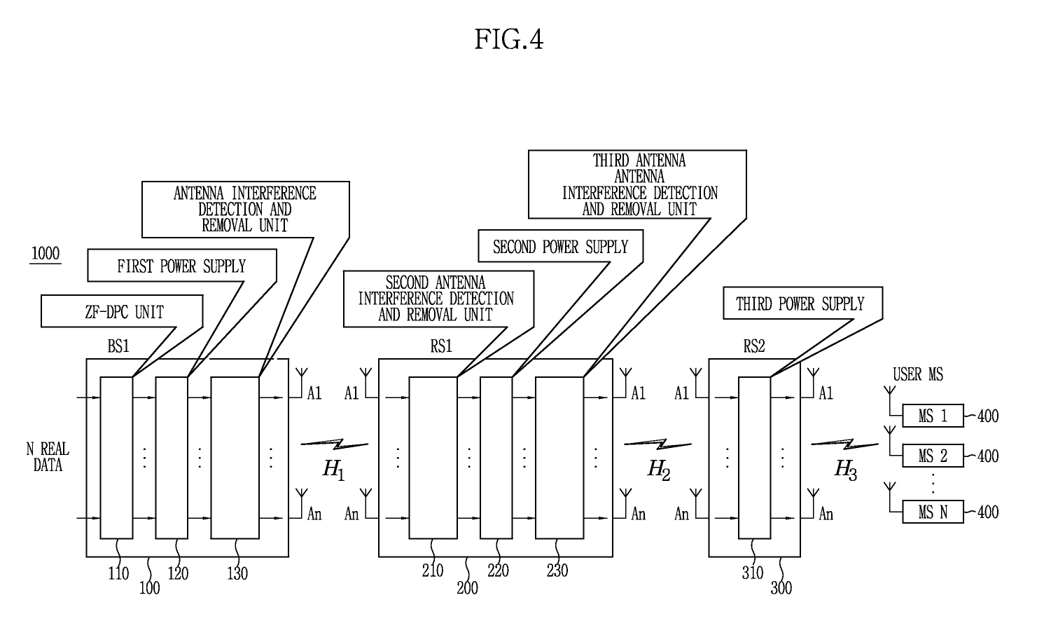

FIG. 4 is a block diagram of a MIMO relay system on a mobile communication network according to a second exemplary embodiment of the present invention.

Referring to FIG. 4, a MIMO relay system 1000 according to the second exemplary embodiment has the same components as described in the first exemplary embodiment and includes a first BS (BS1) 100 having multiple transmit/receive antennas in a first cell, a first RS (RS1) 200 having multiple transmit/receive antennas in the first cell, a second RS (RS2) 300 having multiple transmit/receive antennas in a second cell, and a user MS 400 located in the second cell.

The MIMO relay system 1000 further includes a second BS (BS2) 500 having multiple antennas in the second cell.

A first MIMO channel H₁ is formed between the first BS 100 and the first RS 200 belonging to the first cell. A second MIMO channel H₂ is formed between the first RS 200 belonging to the first cell and the second RS 300 belonging to the second cell.

A MISO channel H₃ is formed between the second RS 300 and the user MS 400.

In a communication environment having the same conditions as in the first exemplary embodiment, a signal processing process in the MIMO relay system 1000 according to the second exemplary embodiment is different from that described in the first exemplary embodiment.

That is, when the first BS 100 transmits real data to the user MS 400 located in the second cell, a relay and signal processing method of the first or second RS 200 or 300 is different from the first exemplary embodiment.

When the first BS 100 according to the second exemplary embodiment of the present invention transmits a payload or real data containing N different multimedia information values to the user MS 400 located in the second cell, user interference generated from user MSs located in the second cell is first removed by applying the user interference to a ZF-DPC unit 110.

The first BS 100 provides the first RS 200 located in the first cell with N user interference-removed real data converted and generated by removing the user interference from N real data by applying N different powers P₁, P₂, - - - , P_{N} to the N user interference-removed real data in 1:1 correspondence.

The N user interference-removed real data are amplified and converted into N different power real data by a composite operation with the N different powers P₁, P₂, - - - , P_{N} provided from a first power supply 120 of the first BS 100 in 1:1 correspondence.

When the first MIMO channel H₁ is formed, the first BS 100 detects first transmit antenna interference affecting its multiple transmit antennas through an internally configured first antenna interference detection and removal unit 130.

The first BS 100 generates N different first BS real data signal-converted by removing the first transmit antenna interference from the N different power real data using the first antenna interference detection and removal unit 130 and provides the first RS 200 located in the first cell with the N different first BS real data.

Subsequently, when the first MIMO channel H₁ is formed with the first BS 100, the first RS 200 detects receive antenna interference affecting its multiple receive antennas through an internally configured second antenna interference detection and removal unit 210.

The first RS 200 generates N different first relay reception stage interference-removed real data signal-converted by removing the receive antenna interference from the N different first BS real data using the second antenna interference detection and removal unit 210.

The first RS 200 processes signals of the N different first relay reception stage interference-removed real data corresponding to result values of the previous step using a half-duplex communication mode in which transmission and reception are time-divided and an AF mode.

In a first time slot ts1, the first RS 200 performs signal amplification by applying N different powers k₁₁, k₁₂, - - - , k_{1N} provided from an internally configured second power supply 220 to the N different first relay reception stage interference-removed real data in 1:1 correspondence.

When the second MIMO channel H₂ and the MISO channel H₃ are formed after generating N different first relay amplification real data converted and processed by the signal amplification, the first RS 200 detects second and third transmit antenna interference affecting multiple transmit antennas of the first and second RSs 200 and 300 through an internally configured third antenna interference detection and removal unit 230.

The first RS 200 generates N different first relay real data signal-converted by removing the second and third transmit antenna interference from the N different first relay amplification real data using the third antenna interference detection and removal unit 230, and provides the second RS 300 located in the second cell with the N different first relay real data.

In a second time slot ts2, the first RS 200 receives N different first BS real data from the first BS 100.

In summary, the first RS 200 according to the second exemplary embodiment of the present invention applies the half-duplex communication mode and the AF mode, removes the receive antenna interference from the N different first BS real data transmitted from the first BS 100, performs signal amplification by the N different powers k₁₁, k₁₂, - - - , k_{1N} in 1:1 correspondence in the first time slot ts1, and provides the second RS 300 with the N different first relay real data from which the second and third transmit antenna interference has been removed.

In the second time slot ts2, the first RS 200 receives N different first BS real data from the first BS 100.

Subsequently, the second RS 300 located in the second cell directly follows the half-duplex communication mode and the AF mode applied to the first RS 200.

Since the N different powers k₁₁, k₁₂, - - - , k_{1N} applied to the N different first relay real data input from the first RS 200 have been consumed, the second RS 300 newly applies a second RS amplification gain g₂ required for re-amplification and transmission to the user MS 400 to the N different first relay real data.

That is, the second RS 300 performs signal re-amplification by applying the second RS amplification gain g₂ corresponding to the same transmit power value provided from an internally configured third power supply 310 to the N different first relay real data received from the first RS 200 in the first time slot ts1.

The second RS 300 generates N different second relay real data converted by the signal re-amplification and transmits the N different second relay real data to the user MS 400 located in the second cell.

In the second time slot ts2, the second RS 300 receives N different first relay real data from the first RS 200.

Here, the N different second relay real data are N different multimedia information values whose signals have been processed to be transmitted to at least one selected user MS corresponding to a target end via the first BS, the first RS, and the second RS.

In summary, the second RS 300 applies the half-duplex communication mode and the AF mode and transmits the N different second relay real data to the user MS 400 located in the second cell by amplifying the N different first relay real data transmitted from the first RS 200 in the first time slot st1.

In the second time slot ts2, the second RS 300 receives N different first relay real data from the first RS 200.

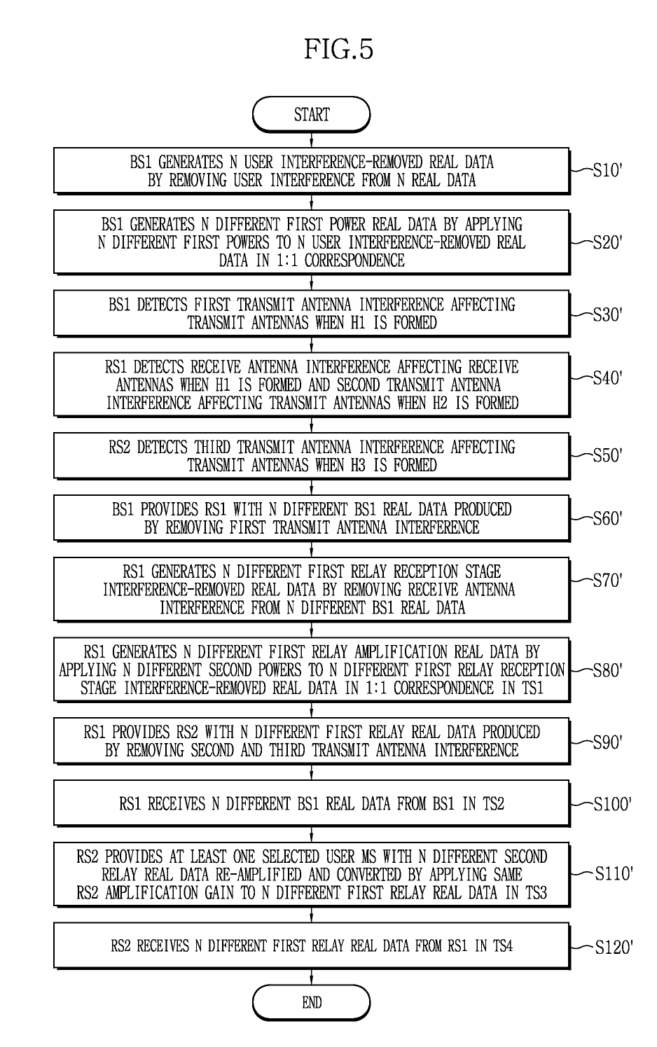

FIG. 5 is a flowchart showing a MIMO relay method on the mobile communication network according to the second exemplary embodiment of the present invention.

Referring to FIG. 5, the MIMO relay method of the second exemplary embodiment operates in a mobile communication environment where the first BS and the first RS are included in the first cell, the second RS and a plurality of user MSs are included in the second cell, the first MIMO channel is formed between the first BS and the first RS, the second MIMO channel is formed between the first RS and the second RS, or the MISO channel is formed between the second RS and at least one selected user MS of the user MSs as follows.

First, the first BS generates N user interference-removed real data by removing user interference generated by multiple user MSs from N real data to be transmitted to the at least one selected user MS (S10′).

The first BS generates N different first power real data amplified and converted by applying N different first powers to the N user interference-removed real data in 1:1 correspondence (S20′).

When the first MIMO channel is formed, the first BS detects first transmit antenna interference affecting its multiple transmit antennas (S30′).

The first RS detects receive antenna interference affecting its multiple receive antennas when the first MIMO channel is formed and second transmit antenna interference affecting its multiple transmit antennas when the second MIMO channel is formed (S40′).

When the MISO channel is formed, the second RS detects third transmit antenna interference affecting its multiple transmit antennas (S50′).

The first BS provides the first RS with N different first BS real data produced by removing the first transmit antenna interference from the N different first power real data (S60′).

The first RS generates N different first relay reception stage interference-removed real data by removing the receive antenna interference from the N different first BS real data (S70′).

The first RS generates N different first relay amplification real data amplified and converted by applying N different second powers to the N different first relay reception stage interference-removed real data in 1:1 correspondence in a first time slot (S80′).

The first RS provides the second RS with N different first relay real data produced by removing the second and third transmit antenna interference from N different first relay amplification real data (S90′).

The first RS receives N different first BS real data from the first BS in time division in a second time slot (S100′).

The second RS provides at least one selected user MS with N different second relay real data re-amplified and converted by applying the same second RS amplification gain to the transmitted N different first relay real data in a third time slot (S110′).

The second RS receives N different first relay real data from the first RS in time division in a fourth time slot (S120′).

Additional operations of devices configured inside the first BS, the first RS, and the second RS are as follows.

The first BS internally includes a ZF-DPC unit, a first power supply, and a first antenna interference detection and removal unit.

The ZF-DPC unit of the first BS generates N user interference-removed real data by removing user interference generated by multiple user MSs from N real data.

The first power supply generates N different first power real data amplified and converted by applying N different first powers to the N user interference-removed real data in 1:1 correspondence.

The first antenna interference and removal unit generates N different first BS real data signal-converted by removing first transmit antenna interference from the N different first power real data.

The first RS internally includes a second antenna interference detection and removal unit, a second power supply, and a third antenna interference and removal unit. The second RS includes a third power supply.

The second antenna interference detection and removal unit of the first RS generates N different first relay reception stage interference-removed real data by removing receive antenna interference generated by multiple receive antennas from the N different first BS real data.

The second power supply generates N different first relay amplification real data amplified and converted by applying N different second powers to the N different first relay reception stage interference-removed real data in 1:1 correspondence.

The third antenna interference detection and removal unit generates N different first relay real data signal-converted by removing second and third transmit antenna interference from the N different first relay amplification real data.

The third power supply of the second RS generates N different second relay real data re-amplified and converted by applying the same second RS amplification gain to the N different first relay real data.

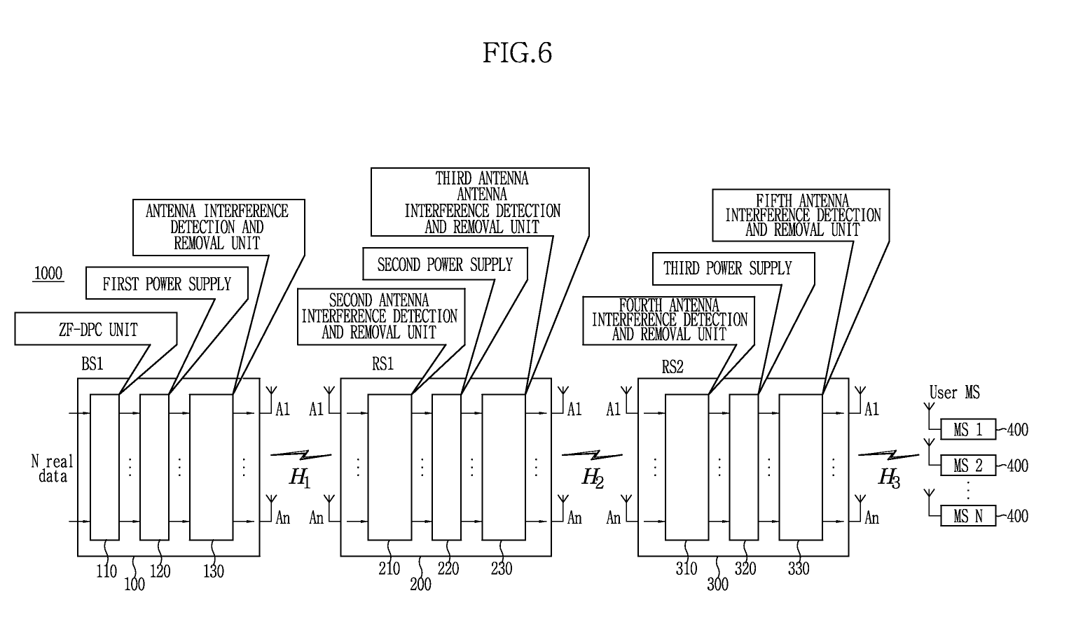

FIG. 6 is a block diagram of a MIMO relay system on a mobile communication network according to a third exemplary embodiment of the present invention.

Referring to FIG. 6, a MIMO relay system 1000 according to the third exemplary embodiment has the same components as described in the first and second exemplary embodiments and includes a first BS 100 having multiple transmit/receive antennas in a first cell, a first RS 200 having multiple transmit/receive antennas in the first cell, a second RS 300 having multiple transmit/receive antennas in a second cell, and a user MS 400 located in the second cell.

The MIMO relay system 1000 further includes a second BS 500 having a plurality of antennas in the second cell.

A first MIMO channel H₁ is formed between the first BS 100 and the first RS 200 belonging to the first cell. A second MIMO channel H₂ is formed between the first RS 200 belonging to the first cell and the second RS 300 belonging to the second cell.

A MISO channel H₃ is formed between the second RS 300 and the user MS 400.

In a communication environment having the same conditions as the first and second exemplary embodiments, a signal processing process in the MIMO relay system 1000 according to the third exemplary embodiment is different from those described in the first and second exemplary embodiments.

That is, when the first BS 100 transmits real data to the user MS 400 located in the second cell, a relay and signal processing method of the first or second RS 200 or 300 is different from the first and second exemplary embodiments.

When the first BS 100 according to the third exemplary embodiment of the present invention transmits a payload or real data containing N different multimedia information values to the user MS 400 located in the second cell, user interference generated from user MSs located in the second cell is first removed by applying the user interference to a ZF-DPC unit 110.

The first BS 100 provides the first RS 200 located in the first cell with N user interference-removed real data converted and generated by removing the user interference from N real data by applying N different powers P₁, P₂, - - - , P_{N} to the N user interference-removed real data in 1:1 correspondence.

The N user interference-removed real data are amplified and converted into N different power real data by a composite operation with the N different powers P₁, P₂, - - - , P_{N} provided from a first power supply 120 of the first BS 100 in 1:1 correspondence.

When the first MIMO channel H₁ is formed, the first BS 100 detects first transmit antenna interference affecting its multiple transmit antennas through an internally configured first antenna interference detection and removal unit 130.

The first BS 100 generates N different first BS real data signal-converted by removing the first transmit antenna interference from the N different power real data using the first antenna interference detection and removal unit 130 and provides the first RS 200 located in the first cell with the N different first BS real data.

Subsequently, when the first MIMO channel H₁ is formed with the first BS 100, the first RS 200 detects receive antenna interference affecting its multiple receive antennas through an internally configured second antenna interference detection and removal unit 210.

The first RS 200 generates N different first relay reception stage interference-removed real data signal-converted by removing the receive antenna interference from the N different first BS real data using the second antenna interference detection and removal unit 210.

The first RS 200 processes signals of the N different first relay reception stage interference-removed real data corresponding to result values of the previous step using a half-duplex communication mode in which transmission and reception are time-divided and an AF mode.

In a first time slot ts1, the first RS 200 performs signal amplification by applying N different powers k₁₁, k₁₂, - - - , k_{1N} provided from an internally configured second power supply 220 to the N different first relay reception stage interference-removed real data in 1:1 correspondence.

When the second MIMO channel H₂ is formed after generating N different first relay amplification real data converted and processed by the signal amplification, the first RS 200 detects second transmit antenna interference affecting its multiple transmit antennas through an internally configured third antenna interference detection and removal unit 230.

The first RS 200 generates N different first relay real data signal-converted by removing the second transmit antenna interference from the N different first relay amplification real data using the third antenna interference detection and removal unit 230 and provides the second RS 300 located in the second cell with the N different first relay real data.

In a second time slot ts2, the first RS 200 receives N different first BS real data from the first BS 100.

In summary, the first RS 200 according to the third exemplary embodiment of the present invention applies the half-duplex communication mode and the AF mode, removes the receive antenna interference from the N different first BS real data transmitted from the first BS 100, performs signal amplification by the N different powers k₁₁, k₁₂, - - - , k_{1N} in 1:1 correspondence in the first time slot ts1, and provides the second RS 300 with the N different first relay real data from which the second transmit antenna interference has been removed.

In the second time slot ts2, the first RS 200 receives N different first BS real data from the first BS 100.

Subsequently, when the second MIMO channel H₂ is formed with the first RS 200, the second RS 300 detects receive antenna interference affecting its multiple receive antennas through an internally configured fourth antenna interference detection and removal unit 310.

The second RS 300 generates N different second relay reception stage interference-removed real data signal-converted by removing the receive antenna interference from N different first relay real data using the fourth antenna interference detection and removal unit 310.

The second RS 300 located in the second cell directly follows the half-duplex communication mode and the AF mode applied to the first RS 200.

Since the N different powers k₁₁, k₁₂, - - - , k_{1N} applied to the N different first relay real data input applied by the first RS 200 have been consumed, the second RS 300 performs signal re-amplification by applying N different powers k₂₁, k₂₂, - - - , k_{2N} provided from an internally configured third power supply 320 to the second relay reception stage interference-removed real data in 1:1 correspondence in the first time slot ts1.

When the MISO channel H₃ is formed after generating N different second relay amplification real data converted and processed by the signal amplification, the second RS 300 detects third transmit antenna interference affecting its multiple transmit antennas through an internally configured fifth antenna interference detection and removal unit 330.

The second RS 300 generates N different second relay real data signal-converted by removing the third transmit antenna interference from the N different second relay amplification real data using the fifth antenna interference detection and removal unit 330 and transmits the N different second relay real data to the user MS 400 located in the second cell.

In the second time slot ts2, the second RS 300 receives N different first relay real data from the first RS 200.

Here, the N different second relay real data are N different multimedia information values whose signals have been processed to be transmitted to at least one selected user MS corresponding to a target end via the first BS, the first RS, and the second RS.

In summary, the second RS 300 according to the third exemplary embodiment of the present invention applies the half-duplex communication mode and the AF mode, removes the receive antenna interference from the N different first relay real data transmitted from the first RS 200, performs signal amplification by the N different powers k₂₁, k₂₂, - - - , k_{2N} in 1:1 correspondence in the first time slot ts1, and provides the user MS 400 with the N different second relay real data from which the third transmit antenna interference has been removed.

In the second time slot ts2, the second RS 300 receives N different first relay real data from the first RS 200.

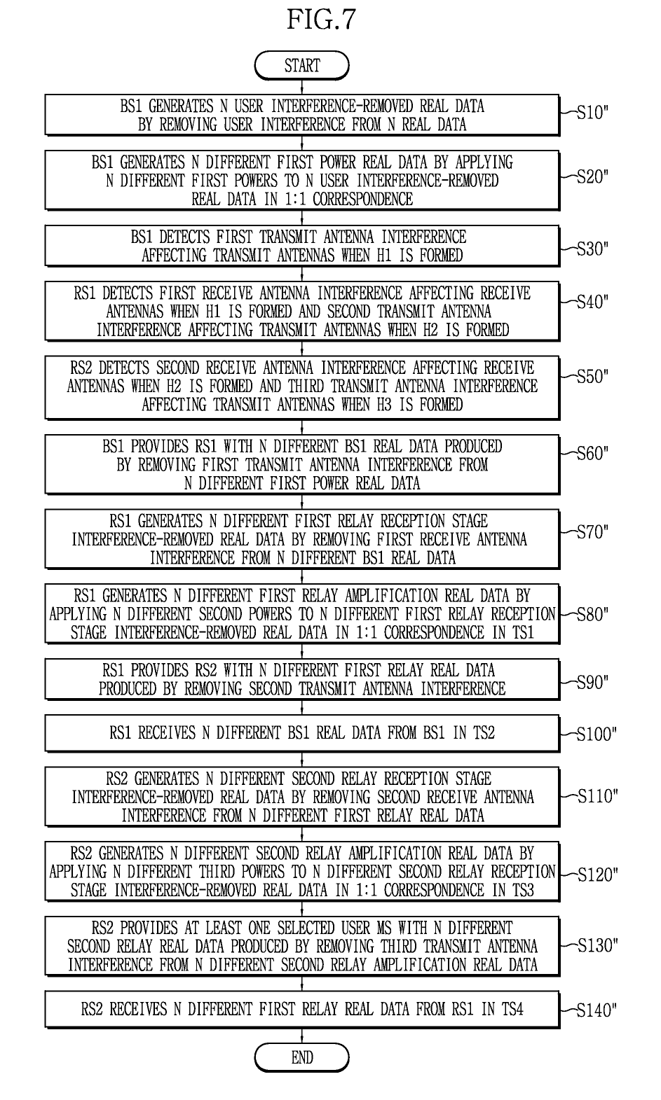

FIG. 7 is a flowchart showing a MIMO relay method on the mobile communication network according to the third exemplary embodiment of the present invention.

Referring to FIG. 7, the MIMO relay method of the third exemplary embodiment operates in a mobile communication environment where the first BS and the first RS are included in the first cell, the second RS and a plurality of user MSs are included in the second cell, the first MIMO channel is formed between the first BS and the first RS, the second MIMO channel is formed between the first RS and the second RS, or the MISO channel is formed between the second RS and at least one selected user MS of the user MSs as follows.

First, the first BS generates N user interference-removed real data by removing user interference generated by multiple user MSs from N real data to be transmitted to the at least one selected user MS (S10″).

The first BS generates N different first power real data amplified and converted by applying N different first powers to the N user interference-removed real data in 1:1 correspondence (S20″).

When the first MIMO channel is formed, the first BS detects first transmit antenna interference affecting its multiple transmit antennas (S30″).

The first RS detects first receive antenna interference affecting its multiple receive antennas when the first MIMO channel is formed and second transmit antenna interference affecting its multiple transmit antennas when the second MIMO channel is formed (S40″).

The second RS detects second receive antenna interference affecting its multiple receive antennas when the second MIMO channel is formed and third transmit antenna interference affecting its multiple transmit antennas when the MISO channel is formed (S50″).

The first BS provides the first RS with N different first BS real data produced by removing the first transmit antenna interference from the N different first power real data (S60″).

The first RS generates N different first relay reception stage interference-removed real data by removing the first receive antenna interference from the transmitted N different first BS real data (S70″).

The first RS generates N different first relay amplification real data amplified and converted by applying N different second powers to the N different first relay reception stage interference-removed real data in 1:1 correspondence in a first time slot (S80″).

The first RS provides the second RS with N different first relay real data produced by removing the second transmit antenna interference from the N different first relay amplification real data (S90″).

The first RS receives N different first BS real data from the first BS in time division in a second time slot (S100″).

The second RS generates N different second relay reception stage interference-removed real data by removing the second receive antenna interference from the transmitted N different first relay real data (S110″).

The second RS generates N different second relay amplification real data re-amplified and converted by applying N different third powers to the N different second relay reception stage interference-removed real data in 1:1 correspondence in a third time slot (S120″).

The second RS provides at least one selected user MS with N different second relay real data produced by removing the third transmit antenna interference from the N different second relay amplification real data (S130″).

The second RS receives N different first relay real data from the first RS in time division in a fourth time slot (S140″).

Additional operations of devices configured inside the first BS, the first RS, and the second RS are as follows.

The first BS internally includes a ZF-DPC unit, a first power supply, and a first antenna interference detection and removal unit.

The ZF-DPC unit of the first BS generates N user interference-removed real data by removing user interference generated by multiple user MSs from N real data.

The first power supply generates N different first power real data amplified and converted by applying N different first powers to the N user interference-removed real data in 1:1 correspondence.

The first antenna interference and removal unit generates N different first BS real data signal-converted by removing first transmit antenna interference from the N different first power real data.

The first RS internally includes a second antenna interference detection and removal unit, a second power supply, and a third antenna interference and removal unit.

The second antenna interference detection and removal unit of the first RS generates N different first relay reception stage interference-removed real data by removing receive antenna interference generated by its multiple receive antennas from the N different first BS real data.

The second power supply generates N different first relay amplification real data amplified and converted by applying N different second powers to the N different first relay reception stage interference-removed real data in 1:1 correspondence.

The third antenna interference detection and removal unit generates N different first relay real data signal-converted by removing second transmit antenna interference from the N different first relay amplification real data.

The second BS internally includes a fourth antenna interference detection and removal unit, a third power supply, and a fifth antenna interference detection and removal unit.

The fourth antenna interference and removal unit generates N different second relay reception stage interference-removed real data by removing receive antenna interference generated by its multiple receive antennas from the N different first relay real data.

The third power supply generates N different second relay amplification real data amplified and converted by applying N different third powers to the N different second relay reception stage interference-removed real data in 1:1 correspondence.

The fifth antenna interference detection and removal unit generates N different second relay real data signal-converted by removing third transmit antenna interference from the N different second relay amplification real data.

According to exemplary embodiments of the present invention, a MIMO relay system and method perform signal processing to provide requested real data to at least one selected user MS sequentially connected to a first RS located in a first cell and a second RS located in a second cell using spare frequency capacity allocated to a first BS of the first cell instead of a second BS of the second cell that drops the requested real data due to its frequency capacity being exceeded, thereby improving reliability of seamless real data input/output in relay communication, reducing call drop probability, and raising availability of frequency capacity by automatically adjusting frequency capacity allocated between cells.

While exemplary embodiments of the present invention have been described above, it will be apparent to those skilled in the art that various changes and modifications can be made to the described exemplary embodiments without departing from the spirit or scope of the invention defined by the appended claims and their equivalents.

What is claimed is:

1. A Multiple-Input Multiple-Output (MIMO) relay system, comprising:
a first cell;
a first Base Station (BS) and a first Relay Station (RS) located in the first cell;
a second cell;
a second BS, a second RS, and at least one selected user Mobile Station (MS) of a plurality of user MSs located in the second cell,
wherein the system processes, when the at least one user MS requests real data to be received by accessing the second BS whose frequency capacity has been exceeded, signals to enable the requested real data to be provided to the at least one user MS sequentially connected to the first and second RSs using spare frequency capacity allocated to the first BS instead of the second BS which drops the requested real data.

2. A Multiple-Input Multiple-Output (MIMO) relay system, comprising:
a first cell;
a first Base Station (BS) and a first Relay Station (RS) located in the first cell;
a second cell;
a second RS dropping requested N real data, a second RS, and at least one selected user Mobile Station (MS) of a plurality of user MSs are located in the second cell;
a first MIMO channel formed between the first BS and the first RS;
a second MIMO channel formed between the first RS and the second RS; and
a Multiple-Input Single-Output (MISO) channel formed between the second RS and the at least one selected user MS, wherein:
the first BS has multiple transmit antennas in which first transmit antenna interference occurs when the first MIMO channel is formed and generates and transmits N different first BS real data after removing user interference generated by user MSs from the N real data and removes the first transmit antenna interference from N information values amplified and converted by applying N different powers in 1:1 correspondence;
the first RS has multiple transmit antennas in which second transmit antenna interference occurs when the second MIMO channel is formed, transmits N different first relay real data amplified and converted by applying a first RS amplification gain to the transmitted N different first BS real data in a first time slot, and receives the N different first BS real data from the first BS in a second time slot;
the second RS has multiple transmit antennas in which third transmit antenna interference occurs when the MISO channel is formed, provides the at least one selected user MS with N different second relay real data re-amplified and converted by applying a second RS amplification gain to the transmitted N different first relay real data in a third time slot, and receives the N different first relay real data from the first RS in a fourth time slot; and
the first BS provides the first RS with the N different first BS real data signal-processed by removing the second and third transmit antenna interference from the amplified and converted N information values.

3. The MIMO relay system of claim 2, wherein the first BS comprises:
a Zero-Forcing Dirty Paper Coding (ZF-DPC) unit generating N user interference-removed real data by removing the user interference generated by the user MSs from the N real data;
a first power supply generating N different power real data amplified and converted by applying the N different powers to the N user interference-removed real data in 1:1 correspondence; and
an antenna interference detection and removal unit generating the N different first BS real data signal-converted by removing all the first, second, and third transmit antenna interference from the N different power real data.

4. The MIMO relay system of claim 2, wherein the first RS comprises:
a second power supply generating the N different first relay real data amplified and converted by applying the same first RS amplification gain to the N different first BS real data.

5. The MIMO relay system of claim 2, wherein the second RS comprises:
a third power supply generating the N different second relay real data re-amplified and converted by applying the same second RS amplification gain to the N different first relay real data.

6. The MIMO relay system of claim 5, wherein the N different second relay real data are N different multimedia information values signal-processed to be transmitted to the at least one selected user MS corresponding to a target end via the first BS, the first RS, and the second RS.

7. A Multiple-Input Multiple-Output (MIMO) relay system, comprising:
a first cell;
a first Base Station (BS) and a first Relay Station (RS) located in the first cell;
a second cell;
a second RS dropping requested N real data, a second RS, and at least one selected user Mobile Station (MS) of a plurality of user MSs located in the second cell;
a first MIMO channel formed between the first BS and the first RS;
a second MIMO channel formed between the first RS and the second RS; and
a MISO channel formed between the second RS and the at least one selected user MS, wherein:
the first BS has multiple transmit antennas in which first transmit antenna interference occurs when the first MIMO channel is formed, and generates and transmits N different first BS real data after removing user interference generated by user MSs from the N real data, and removes the first transmit antenna interference from N information values amplified and converted by applying N different first powers in 1:1 correspondence;
the first RS has multiple transmit and receive antennas in which receive antenna interference occurs when the first MIMO channel is formed and second transmit antenna interference occurs when the second MIMO channel is formed, generates and transmits N different first relay real data after removing the receive antenna interference from the transmitted N different first BS real data and removing the second transmit antenna interference from N second information values amplified and converted by applying N different second powers in 1:1 correspondence in a first time slot, and receives the N different first BS real data from the first BS in a second time slot; and
the second RS has multiple transmit antennas in which third transmit antenna interference occurs when the MISO channel is formed, provides the at least one selected user MS with N different second relay real data re-amplified and converted by applying a second RS amplification gain to the transmitted N different first relay real data in a third time slot, and receives the N different first relay real data from the first RS in a fourth time slot; and
the first RS provides the second RS with the N different first relay real data signal-processed by removing the third transmit antenna interference from the amplified and converted N information values.

8. The MIMO relay system of claim 7, wherein the first BS comprises:
a ZF-DPC unit generating N user interference-removed real data by removing the user interference generated by the user MSs from the N real data;
a first power supply generating N different first power real data amplified and converted by applying the N different first powers to the N user interference-removed real data in 1:1 correspondence; and
a first antenna interference detection and removal unit generating the N different first BS real data signal-converted by removing the first transmit antenna interference from the N different first power real data.

9. The MIMO relay system of claim 7, wherein the first RS comprises:
a second antenna interference detection and removal unit generating N different first relay reception stage interference-removed real data by removing the receive antenna interference generated by the multiple receive antennas from the N different first BS real data;
a second power supply generating N different first relay amplification real data amplified and converted by applying N different second powers to the N different first relay reception stage interference-removed real data in 1:1 correspondence; and
a third antenna interference detection and removal unit generating the N different first relay real data signal-converted by removing the second and third transmit antenna interference from the N different first relay amplification real data.

10. The MIMO relay system of claim 7, wherein the second RS comprises:
a third power supply generating the N different second relay real data re-amplified and converted by applying the same second RS amplification gain to the N different first relay real data.

11. The MIMO relay system of claim 10, wherein the N different second relay real data are N different multimedia information values signal-processed to be transmitted to the at least one selected user MS corresponding to a target end via the first BS, the first RS, and the second RS.

12. A Multiple-Input Multiple-Output (MIMO) relay method for a MIMO relay system in which a first BS and a first RS are located in a first cell, a second RS dropping requested N real data, a second RS, and at least one selected user MS of a plurality of user MSs are located in a second cell, a first MIMO channel is formed between the first BS and the first RS, a second MIMO channel is formed between the first RS and the second RS, and a MISO channel is formed between the second RS and the at least one selected user MS, the method comprising:
generating, by the first BS, N user interference-removed real data by removing user interference generated by user MSs from the N real data;
generating, by the first BS, N different first power real data amplified and converted by applying N different first powers to the N user interference-removed real data in 1:1 correspondence;
detecting, by the first BS, first transmit antenna interference affecting its multiple transmit antennas when the first MIMO channel is formed;
detecting, by the first RS, first receive antenna interference affecting its multiple receive antennas when the first MIMO channel is formed and second transmit antenna interference affecting its multiple transmit antennas when the second MIMO channel is formed;
detecting, by the second RS, second receive antenna interference affecting its multiple receive antennas when the second MIMO channel is formed and third transmit antenna interference affecting its multiple transmit antennas when the MISO channel is formed;
providing, by the first BS, the first RS with N different first BS real data produced by removing the first transmit antenna interference from the N different first power real data;
generating, by the first RS, N different first relay reception stage interference-removed real data by removing the first receive antenna interference from the N different first BS real data;
generating, by the first RS, N different first relay amplification real data amplified and converted by applying N different second powers to the N different first relay reception stage interference-removed real data in 1:1 correspondence in a first time slot;
providing, by the first RS, the second RS with N different first relay real data produced by removing the second transmit antenna interference from the N different first relay amplification real data;
receiving, by the first RS, N different first BS real data from the first BS in a second time slot;
generating, by the second RS, N different second relay reception stage interference-removed real data by removing the second receive antenna interference from the provided N different first relay real data;
generating, by the second RS, N different second relay amplification real data re-amplified and converted by applying N different third powers to the N different second relay reception stage interference-removed real data in 1:1 correspondence in a third time slot;
providing, by the second RS, the at least one selected user MS with N different second relay real data produced by removing the third transmit antenna interference from the N different second relay amplification real data; and
receiving, by the second RS, N different first relay real data from the first RS in a fourth time slot.

13. The MIMO relay method of claim 12, further comprising: in the first BS,
generating, by a ZF-DPC unit, the N user interference-removed real data by removing the user interference generated by the user MSs from the N real data.
generating, by a first power supply, the N different first power real data amplified and converted by applying the N different first powers to the N user interference-removed real data in 1:1 correspondence; and
generating, by a first antenna interference and removal unit, generates the N different first BS real data signal-converted by removing the first transmit antenna interference from the N different first power real data.

14. The MIMO relay method of claim 12, further comprising: in the first RS,
generating, by a second antenna interference detection and removal unit, the N different first relay reception stage interference-removed real data by removing the receive antenna interference generated by its multiple receive antennas from the N different first BS real data;
generating, by a second power supply, the N different first relay amplification real data amplified and converted by applying the N different second powers to the N different first relay reception stage interference-removed real data in 1:1 correspondence; and
generating, by a third antenna interference detection and removal unit, the N different first relay real data signal-converted by removing the second transmit antenna interference from the N different first relay amplification real data.

15. The MIMO relay method of claim 12, further comprising: in the second RS,
generating, by a fourth antenna interference and removal unit, the N different second relay reception stage interference-removed real data by removing the receive antenna interference generated by its multiple receive antennas from the N different first relay real data;
generating, by a third power supply, the N different second relay amplification real data amplified and converted by applying the N different third powers to the N different second relay reception stage interference-removed real data in 1:1 correspondence; and
generating, by a fifth antenna interference detection and removal unit, the N different second relay real data signal-converted by removing the third transmit antenna interference from the N different second relay amplification real data.
